(19) United States
(12) Patent Application Publication
(10) Pub. No.: US 2026/0197672 A1
(43) Pub. Date: Jul. 9, 2026

(54) CELLULAR NETWORK DEGRADATION MITIGATION

(71) Applicant: DISH Wireless L.L.C., Littleton, CO (US)

(72) Inventors: Mostafa Tofighbakhsh, Cupertino, CA (US); Arash Mahmoudian, Littleton, CO (US)

(21) Appl. No.: 19/012,173

(22) Filed: Jan. 7, 2025

(51) Int. Cl. H04W 24/02; H04W 24/08; H04W 24/10

(52) U.S. Cl. CPC H04W 24/02; H04W 24/08; H04W 24/10

(57) ABSTRACT

Systems, method, and machine-readable media may facilitate cellular network degradation mitigation. Electronic communications received from electronic devices of a cellular network system may be processed. The communications may include alarm signals that each may be responsive to a performance degradation and/or a failure, performance data indicative of performance metrics of cellular network components, and/or condition data indicative of conditions of cellular network components. Data composites may be formed from the communications. Digital identifiers may be mapped to cellular network components. A data portion may be extracted and cached. Tags may be appended to the data portion that indicate: the digital identifiers; a temporal specification; and/or a recognition specification. Data composites may be used to automatically train cellular network models to create adapted cellular network models. Diagnostic results mapped to particular portions of the cellular network system may be generated based on the adapted cellular network models.

### TECHNICAL FIELD

This disclosure generally relates to wireless networks, and more particularly to systems, methods, and machine-readable media for cellular network degradation mitigation.

### BACKGROUND

Cellular networks are complex and large scale and involve many components often on the order of hundreds of thousands or more. When things go wrong with such systems, pinpointing sources of problems within the complex cellular network may be tremendously challenging. To efficiently troubleshoot problems, a detailed understanding of the network, of how call flows work, and of how routing protocols work is necessary but often insufficient to quickly identify problems, considering the complexities involved and especially when tens, hundreds or more alarms are going off at approximately the same time. The troubleshooting process may be time-consuming, cumbersome, and expensive, particularly when scores of people are needed to try to figure out how to solve operational issues every morning, for example; when crews need to be sent to sites to evaluate issues and resolve the problems; when potentially thousands of people are needed in the field to maintain the cellular network; and when resources may be wasted misdiagnosing or troubleshooting scenarios that do not make the most logical sense. Conventional means for mitigating operational issues experienced in cellular networks are lacking in their capabilities, efficiency, speed, adaptability, flexibility, and reliability.

Thus, there is a need for systems, methods, and machine-readable media that address the foregoing problems. This and other needs are addressed by the present disclosure.

### BRIEF SUMMARY

Certain embodiments generally relate to wireless networks, and more particularly to systems, methods, and machine-readable media for cellular network degradation mitigation.

In one aspect, method for cellular network degradation mitigation is disclosed. The method may include one or a combination of the following. A first plurality of electronic communications received via a network from a plurality of electronic devices of a cellular network system may be processed. The first plurality of electronic communications may include one or more of: alarm signals that each may be responsive to a performance degradation and/or a failure of one or more cellular network components of the cellular network system; first performance data that may be indicative of performance metrics of cellular network components of the cellular network system; and/or first condition data that may be indicative of conditions of cellular network components of the cellular network system. A plurality of data composites may be formed from the first plurality of electronic communications at least in part by, for each electronic communication of the electronic communications, performing one or a combination of the following. The electronic communication may be processed to identify one or more digital identifiers mapped to one or more of the components of the cellular network system. A data portion from the electronic communication may be extracted and cached. One or more tags may be appended to the data portion that indicate: the one or more digital identifiers; a temporal specification corresponding to origination of the data portion; and/or a recognition specification indicative of a recognized type of alarm signal, performance data, and/or condition data corresponding to the data portion. At least some of the plurality of data composites may be used to automatically train one or more cellular network models to create one or more adapted cellular network models. Diagnostic results mapped to particular portions of the cellular network system may be generated based at least in part on the one or more adapted cellular network models.

In another aspect, a system to facilitate cellular network degradation mitigation is disclosed. The system may include one or more processing devices and memory readable by the one or more processing devices and having stored therein processor-readable instructions which, when executed by the one or more processing devices, cause the system to perform one or a combination of the following operations. A first plurality of electronic communications received via a network from a plurality of electronic devices of a cellular network system may be processed. The first plurality of electronic communications may include one or more of: alarm signals that each may be responsive to a performance degradation and/or a failure of one or more cellular network components of the cellular network system; first performance data that may be indicative of performance metrics of cellular network components of the cellular network system; and/or first condition data that may be indicative of conditions of cellular network components of the cellular network system. A plurality of data composites may be formed from the first plurality of electronic communications at least in part by, for each electronic communication of the electronic communications, performing one or a combination of the following. The electronic communication may be processed to identify one or more digital identifiers mapped to one or more of the components of the cellular network system. A data portion from the electronic communication may be extracted and cached. One or more tags may be appended to the data portion that indicate: the one or more digital identifiers; a temporal specification corresponding to origination of the data portion; and/or a recognition specification indicative of a recognized type of alarm signal, performance data, and/or condition data corresponding to the data portion. At least some of the plurality of data composites may be used to automatically train one or more cellular network models to create one or more adapted cellular network models. Diagnostic results mapped to particular portions of the cellular network system may be generated based at least in part on the one or more adapted cellular network models.

In yet another aspect, one or more non-transitory, machine-readable media are disclosed as having machine-readable instructions thereon which, when executed by one or more processing devices, cause a system to perform one or a combination of the following operations. A first plurality of electronic communications received via a network from a plurality of electronic devices of a cellular network system may be processed. The first plurality of electronic communications may include one or more of: alarm signals that each may be responsive to a performance degradation and/or a failure of one or more cellular network components of the cellular network system; first performance data that may be indicative of performance metrics of cellular network components of the cellular network system; and/or first condition data that may be indicative of conditions of cellular network components of the cellular network system. A plurality of data composites may be formed from the first plurality of electronic communications at least in part by, for each electronic communication of the electronic communications, performing one or a combination of the following. The electronic communication may be processed to identify one or more digital identifiers mapped to one or more of the components of the cellular network system. A data portion from the electronic communication may be extracted and cached. One or more tags may be appended to the data portion that indicate: the one or more digital identifiers; a temporal specification corresponding to origination of the data portion; and/or a recognition specification indicative of a recognized type of alarm signal, performance data, and/or condition data corresponding to the data portion. At least some of the plurality of data composites may be used to automatically train one or more cellular network models to create one or more adapted cellular network models. Diagnostic results mapped to particular portions of the cellular network system may be generated based at least in part on the one or more adapted cellular network models.

In various embodiments, the diagnostic results may be caused to be exposed via a diagnostic interface. In various embodiments, a set of one or more electronic communications received via the network from one or more electronic devices of the cellular network system may be processed. The set of one or more electronic communications may include one or more of: one or more alarm signals that may be each responsive to a performance degradation and/or failure of one or more cellular network components of the cellular network system; second performance data that may be indicative of one or more performance metrics of one or more cellular network components of the cellular network system; and/or second condition data that may be indicative of one or more conditions of one or more cellular network components of the cellular network system. The one or more adapted cellular network models may be used to analyze the set of one or more electronic communications to identify one or more root causes of the performance degradation, the failure, the one or more performance metrics, and/or the one or more conditions.

In various embodiments, the generating the diagnostic results may be based at least in part on the identified one or more root causes. In various embodiments, the one or more adapted cellular network models may be pushed to one or more edges of the cellular network. The one or more adapted cellular network models may be used to analyze the set of one or more electronic communications at the one or more edges of the cellular network system. In various embodiments, the generating the diagnostic results may be performed at the one or more edges of the cellular network. The diagnostic results may be exposed via the diagnostic interface at a computing device at the one or more edges of the cellular network system.

In various embodiments, the training the one or more cellular network models may correspond to using the at least some of the plurality of data composites to automatically train a plurality of cellular network models to create a plurality of adapted cellular network models. In various embodiments, each cellular network model of the plurality of adapted cellular network models may be particularized to a particular type of cellular network component. No model of the plurality of adapted cellular network models may be particularized to the same type of cellular network component as another model of the plurality of adapted cellular network models.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a cellular network system, in accordance with example embodiments according to the present disclosure.

FIG. 2 illustrates an embodiment of an architecture for the cellular network system, in accordance with example embodiments according to the present disclosure.

FIG. 3 illustrates an embodiment of a subsystem including a cellular network data aggregation and transformation engine and a cellular network diagnostic modeling engine, in accordance with example embodiments according to the present disclosure.

FIG. 4 illustrates a cellular network diagnostics subsystem to facilitate cellular network monitoring and diagnostics using the deployed models, in accordance with embodiments according to the present disclosure.

FIG. 5 illustrates one example method for cellular network degradation mitigation using cellular network diagnostics and deployed cellular network models and/or associated sets of inferences, in accordance with embodiments of the present disclosure.

FIG. 6 is an illustration of some aspects of one example diagnostics interface presenting some aspects of diagnostic results, in accordance with embodiments according to the present disclosure.

FIG. 7 illustrates one embodiment of a computer system that may perform various steps of the methods provided by various embodiments.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

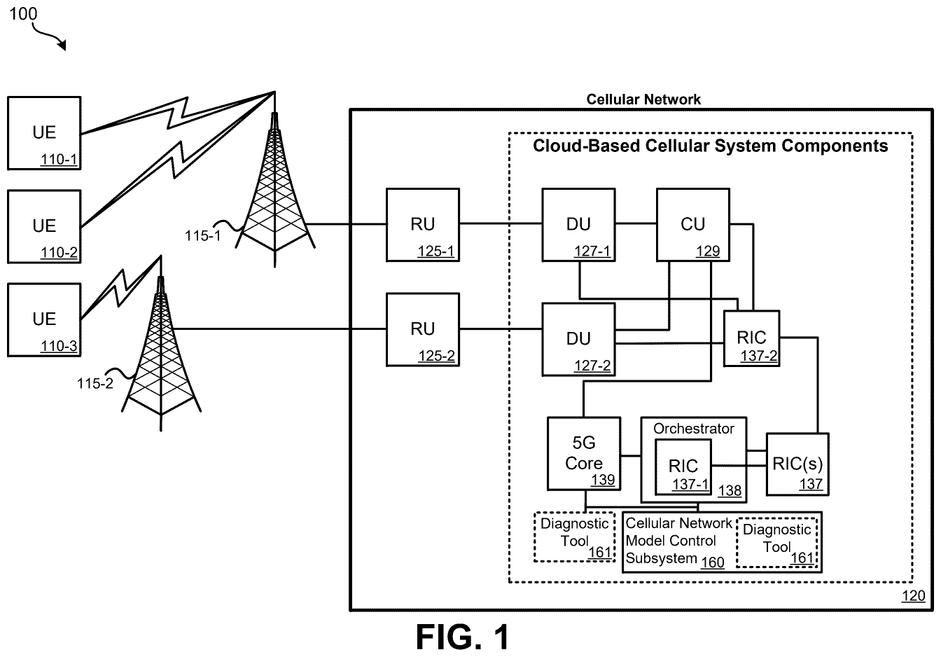

Disclosed embodiments according to the present disclosure may solve the above-mentioned problems. The implementations detailed herein may be implemented on a hardware-based cellular network. A hardware-based cellular network may use specialized or general-purpose computing hardware maintained directly by the cellular network provider to provide cellular services. Alternatively, implementations detailed herein may be performed on a hybrid-cloud cellular network, such as detailed in relation to FIG. 1. Various embodiments will now be discussed in greater detail with reference to the accompanying figures, beginning with FIG. 1.

FIG. 1 illustrates an embodiment of a cellular network system 100 (“system 100”), in accordance with some example embodiments according to the present disclosure. System 100 may include a 5G New Radio (NR) cellular network; other types of cellular networks are also possible. System 100 may include: user equipment 110 (UE 110, UE 110-1, UE 110-2, UE 110-3); base station 115; cellular network 120 infrastructure including hardware, software, switches, routers, etc. ; radio units 125 (“RUs 125”); distributed units 127 (“DUs 127”); centralized unit 129 (“CU 129”); 5G core 139, and orchestrator 138.

FIG. 1 represents a component-level view. The cellular network 120 may include cloud-based cellular system components 123. In a virtualized and cloud-based network, because components may be implemented as software in the cloud, except for components that need to receive and transmit RF, the functionality of the various components may be shifted among different servers to accommodate where the functionality of such components is needed.

UE 110 may represent various types of end-user devices, such as smartphones, cellular modems, cellular-enabled computerized devices, sensor devices, gaming devices, access points (APs), any computerized device capable of communicating via a cellular network, etc. Depending on the location of individual UEs, UE 110 may use RF to communicate with various base stations of cellular network 120. As illustrated, two base stations 115 (BS 115-1, 115-2) are illustrated. In various general examples, an RU may be attached on a tower or under a tower. Real-world implementations of system 100 may include many (e.g., thousands) of base stations, RUs, DUs, and CUs.

In various examples, a DU/CU can be either public cloud or cell site or proprietary LDC. BS 115 may include one or more antennas that allow RUs 125 to communicate wirelessly with UEs 110. RUs 125 may represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture.

One or more RUs, such as RU 125-1, may communicate with DU 127-1. One or more DUs, such as DU 127-1, may communicate with CU 129. CU 129 may communicate with 5G core 139. The specific architecture of cellular network 120 may vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

5G core 139, which may be physically distributed across data centers or located at a central national data center (NDC), may perform various core functions of the network. 5G core 139 may include: authentication server function (AUSF); core access and mobility management function (AMF); data network (DN) which may provide access to various other networks; structured data storage network function (SDSF); and unstructured data storage network function (UDSF). While FIG. 1 illustrates various components of NDC and cellular network 120, it should be understood that other embodiments of cellular network 120 may vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components may be co-located or located at disparate physical server systems. For example, certain components of 5G core 139 may be co-located with components of CU 129.

In a possible O-RAN implementation, DUs 127, CU 129, 5G core 139, and orchestrator 138 may be implemented as software being executed by general-purpose computing equipment, such as in a data center. Therefore, depending on needs, the functionality of a DU, CU, and/or 5G core may be implemented locally to each other and/or specific functions of any given component may be performed by physically separated server systems (e.g., at different server farms). For example, some functions of a CU may be located at a same server facility as where the DU is executed, while other functions are executed at a separate server system.

Kubernetes, or some other container orchestration platform, may be used to create and destroy the logical DU, CU, 5G core units and subunits as needed for the cellular network 120 to function properly. Kubernetes may allow for container deployment, scaling, and management. As an example, if cellular traffic increases substantially in a region, an additional logical DU or components of a DU may be deployed in a data center near where the traffic is occurring without any new hardware being deployed. Rather, processing and storage capabilities of the data center would be devoted to the needed functions. When the need for the logical DU or subcomponents of the DU is no longer needed, Kubernetes may allow for removal of the logical DU.

In some embodiments, the cloud-based cellular system components 123 may include OSS/BSS (operations support system/business support system) that may be configured to monitor the cellular network 120, perform fault management, perform performance management, handle UE faults and underperformance indicators, and/or the like. A service management and orchestration (SMO) system and/or platform may be configured to manage and orchestrate components and network services and functions of the Of-RAN. For example, the deployment, scaling, and management of such virtualized components may be managed by orchestrator 138. Orchestrator 138 may represent various software processes executed by underlying computer hardware. Orchestrator 138 may monitor cellular network 120 and determine the amount and location at which cellular network functions should be deployed to meet or attempt to meet service level agreements (SLAs) across slices of the cellular network.

Various embodiments may provide network slices, network services, or both. The network services provided may include VNFs (virtualized network functions), PNFs (physical network functions), and/or other network services. The VNFs may include software-based functions that may be utilized in conjunction with one or more slices such as security functions, monitoring functions, and/or the like. The PNFs may include hardware components of the cellular network with which the orchestrator 138 may be configured to provide a network slice and/or other network services to a particular client.

The network 120 components such as DUs 127, CU 129, orchestrator 138, and 5G core 139 may include various software components that are required to communicate with each other, handle large volumes of data traffic, and be able to properly respond to changes in the network. In order to ensure not only the functionality and interoperability of such components, but also the ability to respond to changing network conditions and the ability to meet or perform above vendor specifications, significant testing must be performed.

The cellular network 120 may include a cellular network model control subsystem 160 (which may also be referenced herein as control subsystem 160, modeling subsystem 160, or subsystem 160) and one or more diagnostic tools 161. In various embodiments, the subsystem 160 may correspond to one or a combination of one or more portions or all of the cellular network 120, one or more portions or all of cloud-based cellular system components 123, and/or one or more portions or all of the orchestrator 138. In some embodiments, the subsystem 160 may include the orchestrator 138.

The cellular network 120 may include one or more radio access network intelligent controllers (RICs) 137. The system 200 may, in various embodiments, include one or more of the RICs 137 or may be otherwise communicatively coupled with the RICs 137. The system 200 may be configured to control and use the RICs 137 to facilitate various dynamic beamforming features. The RICs 137 may include a non-real-time RIC 137-1, which may be included in the orchestrator 138 and/or SMO layer in some embodiments. The non-real-time RIC 137-1 may be configured with one or more logical functions that facilitate control of the components and resources of the network 120 components, such as DUs 127, CU 129, and RUs 125, as well as facilitating learning and modeling features of the system 200. Additionally or alternatively, the RICs 137 may include a real-time and/or near-real-time RIC 137-2. The RIC 137-2 may be configured with one or more logical functions that facilitate real-time and/or near-real-time control of the components and resources of the network 120 components.

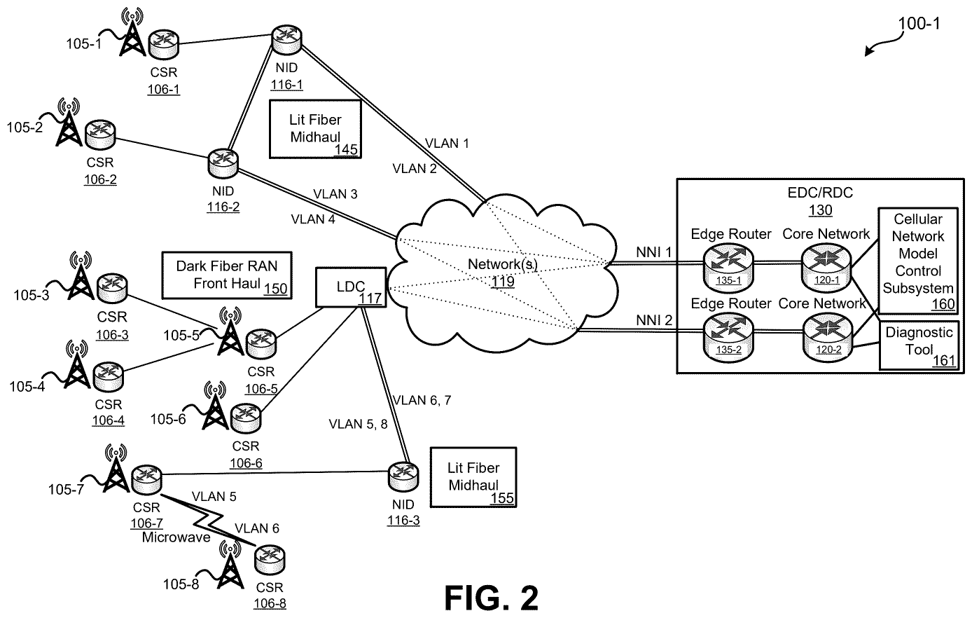

FIG. 2 illustrates an embodiment of an architecture for the cellular network system 100-1 (“system 100-1”). The system 100-1 may correspond to the system 100, with details regarding transport and distribution being illustrated in FIG. 2. Various embodiments according to the present disclosure may include one or a combination of the components of FIG. 2 and may correspond to different variations of thereof. The system 100-1 may include: cell sites 105 (cell site 105-1, cell site 105-2, cell site 105-3, cell site 105-4, cell site 105-5, cell site 105-6, cell site 105-7, cell site 105-8) communicatively coupled to cell site routers (CSRs) 106 (cell site router (CSR) 106-1, CSR 106-2, CSR 106-3, CSR 106-4, CSR 106-5, CSR 106-6, CSR 106-7, CSR 106-8); network interface devices (NIDs) 116 (network interface device (NID) 116-1, NID 116-2, NID 116-3); local data center (LDC) 117; network 119; edge data center (EDC) and regional data center (RDC) 130; edge routers 135 (edge router 135-1, edge router 135-2); cloud-based cellular network components (e.g., 123 in FIG. 1) corresponding to core network 120 (core network 120-1, core network 120-2); the cellular network model control subsystem 160; and/or the like.

The CSRs 106 may communicatively couple the cell sites 105 to other cell sites 105, NIDs 116, and/or the LDC 117. The NIDs 116 may be communicatively coupled to the LDC 117 and/or the network 119 with VLANs 1, 2, 3, 4, 5, 6, 7, 8. Each NID 116 may provide a connection between a CSR 106 and a VLAN, routing traffic between the CSR 106 and the VLAN. Each site may have its own set of one or more VLANs. A lit fiber midhaul 145 may include, for example, NIDs 116-1, 116-2, VLANs 1, 2, 3, 4, and corresponding connections, among other components of the system 100-1. A lit fiber midhaul 155 may include, for example, NID 116-3, VLANs 5, 6, 7, 8, and corresponding connections, among other components of the system 100-1. A dark fiber open radio access network (RAN) front haul 150 may include, for example, cell sites 105-3, 105-4, 105-5, CSRs 106-3, 106-4, 106-5, and the corresponding connections, among other components of the system 100-1. The cell sites 105, LDC 117, other components of the lit fiber midhauls 145, 155 and front haul 150, and/or the like may be connected, via network-to-network interface (NNI) 1, 2 connections, to the cloud-based cellular network components corresponding to network core 140 via dark fiber transport and/or lit fiber transport provided by network 119. Accordingly, the network 119 may include a fiberoptic network, which may include multiprotocol label switching technology.

System 100-1 may correspond to a 5G New Radio (NR) cellular network; other types of cellular networks, such as 6G, 7G, etc. may also be possible. In various embodiments, the cloud-based cellular network components may be executed with the overlay network infrastructure on a third-party cloud-based computing platform or a cloud-based computing platform operated by the same entity that operates the RAN. The cloud-based cellular network components may be executed as specialized software executed by underlying general-purpose computer servers. A cloud-based computing platform may have the ability to devote additional hardware resources to cloud-based cellular network components or implement additional instances of such components when requested. The overlay network infrastructure may be a virtual infrastructure and may include a specialized 5G core built and operated in the cloud with virtual machines to provide 5G services using the compute resources of the underlay cloud infrastructure. The overlay network infrastructure may include a routing architecture may be specially configured to overlay into that cloud environment and may provide for functions that require routing and that are not natively available with the cloud environment—e.g., border gateway protocol configurations, routing content objects with network functions that are virtual machines ultimately up in the cloud, and/or the like.

The cloud-based cellular network components 123 may include one or a combination of the edge routers 135, one or more EDCs and/or one or more RDCs 130. Such data centers may correspond to virtualized instantiations. Each RDC may serve primarily to route data among different data centers. A RDC may be in communication with multiple edge data centers. If data is to be routed among EDCs in direct communication with a RDC, components higher in the hierarchy of the cellular core network may not need to be involved in the routing of data. However, if data is being routed to an EDC not in direct communication with a RDC, a component higher in the hierarchy of the cellular core network may need to be used to complete the routing. Such a hierarchy may allow for data anywhere within the cellular network to be routed to other devices. EDCs and RDCs may collectively be referred to as nodes of the core cellular network. As illustrated, the system 100-1 may be configured with redundant services such that two (as in the illustrated example) or more different platforms may be implemented.

FIG. 2 illustrates some examples for logical connectivity of various components of the system 100-1. While FIG. 2 illustrates various components of the system 100-1, other embodiments of the system 100-1 may vary the arrangement, communication paths, and specific components of the system 100-1. In the example of system 100-1, only a small number of components are illustrated. In reality, the system 100-1 may include a much larger number of components. For example, the system 100-1 may include hundreds or thousands of cell sites 105 and corresponding components and connections. Greater numbers of NIDs 116, LDCs 117, EDCs/RCDs 130, and the like may be present. The system 100-1 may include greater numbers of levels within the hierarchy within the core cellular network and may include, for example, a national data center in some embodiments. Groups of EDCs 130 may have a dedicated bandwidth to communicate with cloud-based cellular network components. Therefore, it should be understood that the number and types of radio access network components that communicate with an EDC 130 may vary. Further, the components of the cellular core network that the EDC 130 communicates with may also vary.

There may be different aggregation points in the system 100-1. For example, a CSR 106 at a cell site 105 may be an aggregation point. The LDCs 117 may be the first aggregation points for the geographically distributed cell sites on dark fiber. An EDC 130 in a market may aggregate the lit fiber cell sites and all the market LDCs'traffic as well. An EDC 130 may also aggregate nearby dark fiber dell sites as well for a collocated LDC 117. An RDC 130 may serve as an aggregation point for multiple markets (EDC traffic). In a market, there may be one or more collocated RCD/EDCs 130, and/or LDCs 117. An NNI, being an interface that specifies signaling and management functions between the network 119 and the EDC/RDC 130, may, for example, aggregate up to 500 sites or more to one pipe to the EDC/RDC 130, in order to connect the pipeline to the cloud-based cellular network components 123.

The subsystem 160 may be communicatively coupled to the core network 130. The subsystem 160 may be executed and implemented with one or more processors, one or more computer systems, one or more other processing devices, one or more servers, one or more server systems, and/or the like. Components such as the subsystem 160, which may include a network diagnostic tool 161, and the 5G core of the core network 140 may include various software components that are required to communicate with each other, handle large volumes of data traffic and are able to properly respond to changes in the network. Detection, evaluation, and diagnostics of problems that arise during operation of the system 100-1 may be performed by the network diagnostic tool 161. The network diagnostic tool 161 may perform various software processes executed by underlying computer hardware. The network diagnostic tool 161 may monitor other components of the system 100-1, assess alarms, and perform diagnostics with respect to the various components of the system 100-1.

In some embodiments, the subsystem 160 and/or the network diagnostic tool 161 may be implemented locally to a data center, such as EDC/RDC 130. In some embodiments, the subsystem 160 and/or the network diagnostic tool 161 may be implemented virtually as software being executed in the cloud with the overlay network infrastructure on top of the cloud underlayment infrastructure. In some embodiments, the subsystem 160 and/or the network diagnostic tool 161 may be implemented as a virtual machine. In the illustrated embodiment of system 100-1, the cloud-based cellular network components may include the subsystem 160 and/or the network diagnostic tool. In various embodiments, the diagnostic tool 161 or instances thereof may be pushed to, and deployed for operation at, edge devices of the cellular network 120, LDCs 117, UEs 110, base stations 115, and/or the like.

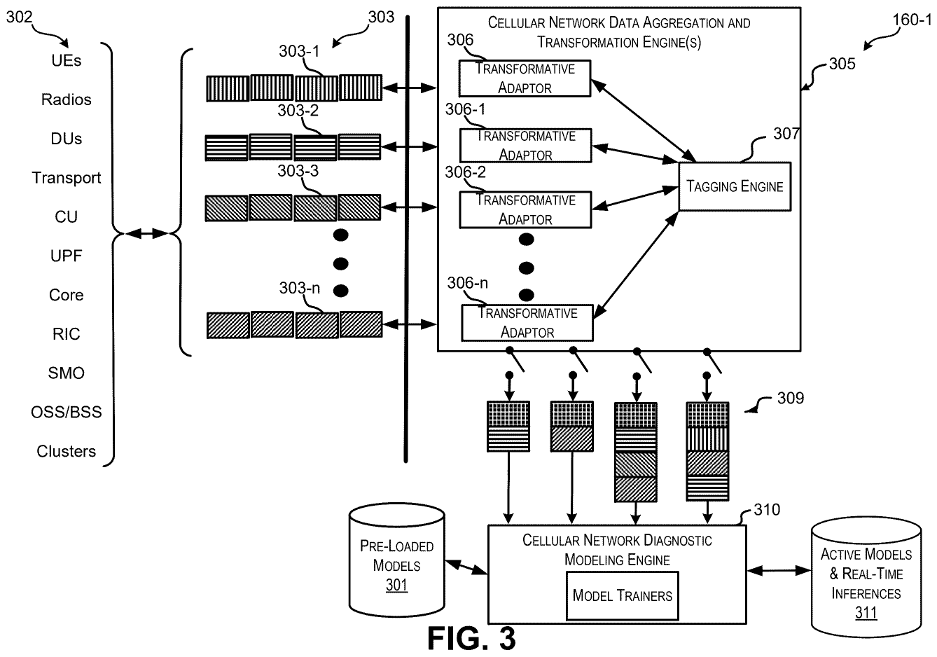

FIG. 3 illustrates an embodiment of the subsystem 160-1 including a cellular network data aggregation and transformation engine 305 (referenced herein as “cellular network engine 305”) and a cellular network diagnostic modeling engine 310 (referenced herein as “diagnostic modeling engine 310”) according to the present disclosure. In various embodiments, the cellular network engine 305 may correspond to a single, integral engine or separate engines working in conjunction. The cellular network engine 305 may filter, extract, cache, append, tag, label, transform, translate, or otherwise adjust cellular network data 303 collected.

The cellular network data 303 may be received via electronic communications received via one or more networks from electronic devices corresponding cellular network components 302 of the cellular network system 100. The cellular network components 302 may, for example, include one or more of UEs, radios, DUs, transport components, CU, UPF, core, RICs, service management orchestration (SMO) components, operations and business support systems (OSS/BSS) components, clusters, and/or the like, such as the corresponding cellular network components disclosed herein. The cellular network data 303 may be received and collected in real time. The cellular network data 303 may correspond to alarm signals that are each responsive to a performance degradation and/or a failure of one or more cellular network components of the cellular network 120 and the cellular network system 100. Additionally or alternatively, the cellular network data 303 may correspond to performance data indicative of performance metrics (e.g., key performance indicators corresponding to uplink throughput, downlink throughput, and/or the like) of cellular network components of the cellular network 120 and the cellular network system 100. Additionally or alternatively, the cellular network data 303 may correspond to condition data indicative of conditions of cellular network components of the cellular network 120 and the cellular network system 100.

In some embodiments, for example, the cellular network data 303 may include network components alarm input that may be indicative of performance and/or conditions. The network components alarm input may include all network device alarm signals that may be received for all network components of the cellular network system 100. For example, the alarm input may correspond to alarm signals triggered by and indicating one or a combination of: a node being detected as unreachable because of a disruption in a heartbeat/keep-alive signal from the node, and then the node being non-responsive to one or more confirmation pings; packet errors; various different faults; a door being opened; device temperatures exceeding one or more thresholds; CPU utilization exceeding one or more thresholds; operating parameters exceeding normal operating conditions and one or more thresholds; alarms on an antennae of a cell tower indicating overvoltage or undervoltage conditions; alarms indicating water in a line preventing proper reflection/propagation of RF signals; loss of power alarms; bursty traffic or network storm that is causing CPU utilization to go too high; communication disruptions from an edge router 135 to the core network 120; issues with a failover link between edge routers 135; and/or the like. The alarm input may be caused by sensors and may correspond to any suitable alarm signal for any component of the system 100. Each alarm signal may include a site identifier (e.g., cell site 1, 4, . . . ), a device identifier (e.g., CSR 1, 4, . . . ) and/or a network identifier (e.g., VLAN 5), a port identifier (e.g., port 47-3), and a type of alarm and/or condition.

The cellular network engine(s) 305 may utilize any one or combination of the interfaces as one or more data acquisition interfaces configured to allow the cellular network engine(s) 305 to gather cellular network data 303 from data sources corresponding to any one or combination of the sources of cellular network data 303 corresponding to alarm signals indicative of performance degradations and/or failures of one or more cellular network components, performance data 303-1 indicative of performance metrics of cellular network components, condition data 303-2 indicative of conditions of cellular network components, and/or the like. The cellular network data 303, which, in some embodiments, may include multiple data packets and/or data streams, may be received via one or more networks, such as a local area network, a Wi-Fi network, or the Internet, from multiple sources (e.g., from a single premises or multiple premises), such as a component or user device that collects at least some of the data included in each data element based at least in part on inputs detected at the component or user device, measurements made by a sensor, and/or data monitored by a monitoring device. The cellular network data 303 may correspond to electronic communications that may include one or more of signals of device interactions or data changes that correspond to alarm signals indicative of performance degradations and/or failures of one or more cellular network components; signals of performance metrics of cellular network components; signals of conditions of cellular network components; and/or signals of processes associated with cellular network components. In some instances, the data cellular network 303 may be collected immediately, or with some delay (e.g., so as to be at an end of a data-collection effort) appended to a data stream or other data packets transmitted directly or indirectly to the cellular network engines 305. In some instances, collected data can be locally or remotely stored and subsequently retrieved (e.g., by a same or different device) to append to a stream or other data packets. A managing server may then, at a defined time or upon detecting a defined type of event (e.g., receiving a data request or detecting a threshold size of a data stream), retrieve the stored data and append the data (e.g., in raw or processed form) to a stream or other data packets. Thus, a source of a stream or other data packets may be a single component or user device or an intermediate monitoring device or system that collects data from multiple components, sensors, and/or user devices. In various embodiments, the cellular network data 303 may correspond to any one or combination of raw data, unstructured data, structured data, information, and/or content which may include text, documents, files, instructions, code, executable files, images, video, audio, and/or any other suitable content suitable for embodiments of the present disclosure. In various instances, data from 10, 100, 1,000 or any number of different sources may be merged together with data generated internally and/or data previously received.

In some embodiments, the subsystem 160 may include a multi-server system that may include specialized data-pulling engines and stream processing engines (e.g., each engine being a server or processing core). According to disclosed embodiments, with data-pulling engines, at least some of the data may be actively gathered and/or pulled from the one or more data sources corresponding to the network components 302. A stream processing engine may be specialized so as to include, for example, stream processors and fast memory buses. In some embodiments, data elements of the received data 303 may be separated, for example, within a stream via a particular (or one of multiple particular) characters or strings, or data elements may begin or end with a particular (or one of multiple particular) characters or strings. In some embodiments, the one or more content acquisition interfaces may include one or more APIs that define protocols and routines for interfacing with the data sources via an API interface. The APIs may specify API calls to/from data source systems. In some embodiments, the APIs may include a plug-in to integrate with an application of a data source component. The one or more data acquisition interfaces, in some embodiments, could use a number of API translation profiles configured to allow interface with the one or more additional applications of the data sources to access data (e.g., a database or other data storage) of the data sources. The API translation profiles may translate the protocols and routines of the data source system to integrate at least temporarily with the system and allow communication by way of API calls.

The cellular network engine 305 may process manifold data sets of the cellular network data 303 that may, for instance, come from different sources or the same source. In various embodiments, this may include applying one or more filtering techniques (or one or more filters) to the data sets, organizing, categorizing, qualifying, and/or comparing the sets of information; detecting, identifying, and/or handling errors/mismatches; identifying redundancies; removing redundancies; discarding data irrelevant to cellular network diagnostics; and/or otherwise processing the data sets. The cellular network engine 305 may form data composites 309 from the cellular network data 303. For example, the cellular network engine 305 may form data composites 309 from the cellular network data 303 based at least in part on the following. The cellular network engine 305 may process each electronic communication corresponding to the data 303 to identify one or more digital identifiers mapped to one or more of the cellular network components 302. From the electronic communication, the cellular network engine 305 may, for example, extract and cache a data portion of the data 303. The cellular network engine 305 may, for example, classify the data portion and may append one or more tags (which may, for example, correspond to one or more labels) to the data portion that indicate: the one or more digital identifiers mapped to the one or more of the cellular network components 302; origins (e.g., location, equipment grouping, etc.) of the alarm signal, performance data, and/or condition data; a temporal specification (e.g., date and/or time specifications, time stamps, etc.) corresponding to origination and/or reception of the data portion; a recognition specification indicative of a recognized type of error, a recognized type of alarm signal, a recognized type of performance data, and/or a recognized type of condition data corresponding to the data portion; sample error information; and/or the like. Such operations may be performed in real time and data 303 that is received in real time.

To facilitate such operations, in some embodiments, the cellular network engine(s) 305 may, for example, include a tagging engine 307 configured to perform extracting field values from data, categorizing/classifying data, and tagging of data. The tagging engine 307 may be continuously labeling data portions extracted from the data 303. In some embodiments, the tagging may be semantic tagging. The tagging engine 307, therefore, may be configured to receive data, read metadata associated with the data, semantically scan the content of the data, and associate one or more tags with the data. The tagging engine 307 may have access to hundreds, thousands, or even more possible tags. These tags may have been input by users, learned, predefined, generated by eternal mapping sources, and/or gathered from other components and/or data storages of the subsystem 160. Various examples of metadata as bases for classification and/or as tags may be include data type, geographic location, unique identifier(s) associated with the network component 302 or premises where the data originated. In some examples, reading metadata associated with data messages may provide meaning and/or give context to the particular data. This meaning and/or context may assist the tagging engine 307 to determine one or more tags to associate with the data.

In some embodiments, the cellular network engine 305 may identify one or more applicable protocols of the data streams and may make certain adjustments to the data (e.g., translations, conversion of formatting of the data, and the like) prior to the classification and tagging. In some embodiments, the cellular network data 303 acquired may be in different formats, according to different data standards, in different message structures, including different types of data, etc. The cellular network data 303 may then be transformed, translated, or otherwise adjusted by the cellular network engine 305 (e.g., with the tagging engine 307). For example, acquired data may be converted from a first format to a second format using one or more conversion rules, which may be user-defined, heuristic, and/or machine-learned. In some embodiments, the cellular network engine 305 may include one or more transformative adaptors 306 that may be associated with the data acquisition interfaces to effect the transformations. The transformative adaptors 306 may be implemented, in various embodiments, in hardware and/or software. In some embodiments, a transformative adaptor 306 may include a hardware device and/or software component that transforms, translates, converts, or otherwise adjusts the acquired data 303.

The tagging engine 307 may recognize identifiers of the above aspects from the data 303 by code mapping, keyword recognition, and/or another suitable method of recognition. In some embodiments, example, the tagging engine 307 may identify keywords and/or codes as distinctive markings, collect and arrange them, and correlate them with recognition criteria (e.g., keyword criteria and/or code system) for the purposes of characterizing each set of data 303, labeling/tagging data portions, and generating data composites 309 from the cellular network data 303. For example, this may include recognizing trigger events corresponding to alarms, performance data satisfying or not satisfying performance value thresholds, condition data indicating certain conditions and/or satisfying or not satisfying condition value thresholds, and/or the like. Such recognition processing may be performed in real time. In some embodiments, the recognition criteria may include keywords identified by any one or combination of words, word stems, phrase, word mappings, and/or like keyword information. The recognition criteria may include weighting assigned to words, word stems, phrase, word mappings, and/or the like. For example, a keyword may be assigned a weight according to its significance. Increased word weights may be mapped to increasing probability of criticality. The recognition criteria may correspond to one or more keyword schemas that are correlated to various criticalities. The recognition criteria may correspond to any other suitable means of linking, for example, via a code system, that may be used to associate recognized codes to specific criticalities. Thus, for example, each trigger event may be scored (e.g., with numerical expressions) according to any one or combination of the various factors disclosed herein and a weight for each trigger event may be determined as a function of a criticality score assigned to the trigger event and comparison to one or more thresholds corresponding to one or more categories of criticality (e.g., low criticality, medium criticality, high criticality, and/or the like).

Accordingly, the data composites 309 may correspond to the processing, filtered, extracted, transformed, classified, and tagged data portions based on the cellular network data 303. In some instances, such a data composite 309 may include such a data portion with no other data portion. In other instances, such a data composite 309 may include such a data portion with one or more other such data portions which have been correlated by the cellular network engine 305. The correlation may be based on identifying similar or related identifiers and/or criteria in certain data 303 (e.g., similar or related network component identifiers, premises identifiers, and/or the like) and/or identifying temporal proximities (e.g., alarms, performance data, and/or condition data received at the same time or within a certain time window).

The data composites 309 may correspond to exhaustive sets of data continuously, regularly, or occasionally pushed to the diagnostic modeling engine 310. The diagnostic modeling engine 310 may use the data composites 309 to automatically train, with one or more model trainers, one or more cellular network models 301 to create one or more adapted cellular network models 311, which each may correspond to an artificial intelligence model or which in the aggregate may correspond to an artificial intelligent model. The diagnostic modeling engine 310 and/or the one or more adapted cellular network models 311 may infer one or more patterns and relationships corresponding to network components 302, failures and/or performance degradations thereof, and corresponding alarms, performance metrics, and/or conditions. The diagnostic modeling engine 310 may include a reasoning module to make logical inferences from a set of the detected and differentiated data corresponding to the data composites 309. In some embodiments, a pattern-based reasoner may be employed to use various statistical techniques in analyzing the data, both current and historical, in order to infer particularized pattern data from the data 303 and composites 309. In some embodiments, a transitive reasoner may be employed to infer relationships of network components 302, failures and/or performance degradations thereof, and corresponding alarms, performance metrics, and/or conditions. In some embodiments, the diagnostic modeling engine 310 and/or the one or more adapted cellular network models 311 may automatically establish and develop the particularized network component pattern data and relationship data. In some embodiments, the diagnostic modeling engine 310 may be configured to employ deep learning to process the composites 309 and train the cellular network models 311. In some embodiments, the diagnostic modeling engine 310 and/or the one or more adapted cellular network models 311 may facilitate machine learning or, more specifically, deep learning, to facilitate creation, development, and/or use of particularized pattern data and relationship data corresponding to network components 302, failures and/or performance degradations thereof, and corresponding alarms, performance metrics, and/or conditions. For instance, the pattern data may include information about any one or combination of network component histories, operations and performance histories, location histories, and/or the like, any set of which may be used to derive one or more patterns of performance data for particular resources and sets of resources and one or more relationships of corresponding network components. Performance metrics may include process metrics, rates of changes in performance metrics, rankings of network components and component sets, and/or the like.

In various embodiments, the diagnostic modeling engine 310 may create and/or train cellular network models 311 and/or associated sets of inferences that are each particularized to a particular type of cellular network component 302. Thus, for example, a cellular network model 311 and/or associated sets of inferences may be particularized to UE (e.g., based at least in part on call drops, locations, user experience like quality of experience metrics, throughput, packet loss, jitter, signal strengths, and/or the like). A cellular network model 311 and/or associated sets of inferences may be particularized to RAN (e.g., based at least in part on RAN-specific details, RRB usage, numbers of users latched, coverage, slices assignments, uplink/downlink data, and/or the like). A cellular network model 311 and/or associated sets of inferences may be particularized to RICs (e.g., based at least in part on E2 interface details, applications reactions such as power level optimization, and/or the like). A cellular network model 311 and/or associated sets of inferences may be particularized to CSRs (e.g., based at least in part on route information and/or the like). Other models and/or associated may be particularized to other network components 302. In some embodiments, no model of the plurality of adapted cellular network models 311 is particularized to the same type of cellular network component 302 as another model of the plurality of adapted cellular network models 311. The plurality of component-particularized cellular network models 311 may be used in aggregate by the subsystem 160 to generate diagnostic results.

Having trained the one or more adapted cellular network models 311, the subsystem 160 may use the models 311 to analyze subsequently received data 303 from the network components 302. The subsequently received data 303 may correspond to a set electronic communications received via the network from one or more electronic devices of the cellular network system 100. The subsequently received data 303 may include one or more alarm signals that are each responsive to a performance degradation and/or failure of one or more cellular network components of the cellular network system 100, additional performance data indicative of one or more performance metrics of one or more cellular network components of the cellular network system 120; and/or additional condition data indicative of one or more conditions of one or more cellular network components of the cellular network system 120. The subsystem 160 may use the models 311 to analyze such data 303 to identify one or more root causes of the performance degradation, the failure, the one or more performance metrics, and/or the one or more conditions. The subsystem 160 may generate diagnostic results mapped to particular portions of the cellular network system based at least in part on the one or more adapted cellular network models 311. The generating the diagnostic results is based at least in part on the identified one or more root causes.

In some embodiments, the one or more cellular network models 311 and/or associated sets of inferences may be pushed to one or more edges of the cellular network system 100, near the infrastructure environment. This may include distributing one or more cellular network models 311 and/or associated sets of inferences to UEs 110, base stations 115, RUs 125, cell sites 105, LDCs 117, etc. for storage and use at the one or more edges of the cellular network system 100. In some embodiments, the distributed one or more cellular network models 311 and/or associated sets of inferences may be used to generate diagnostic results at the one or more edges of the cellular network system 100. The diagnostic results may be exposed via a diagnostic interface at a computing device at the one or more edges of the cellular network system 100.

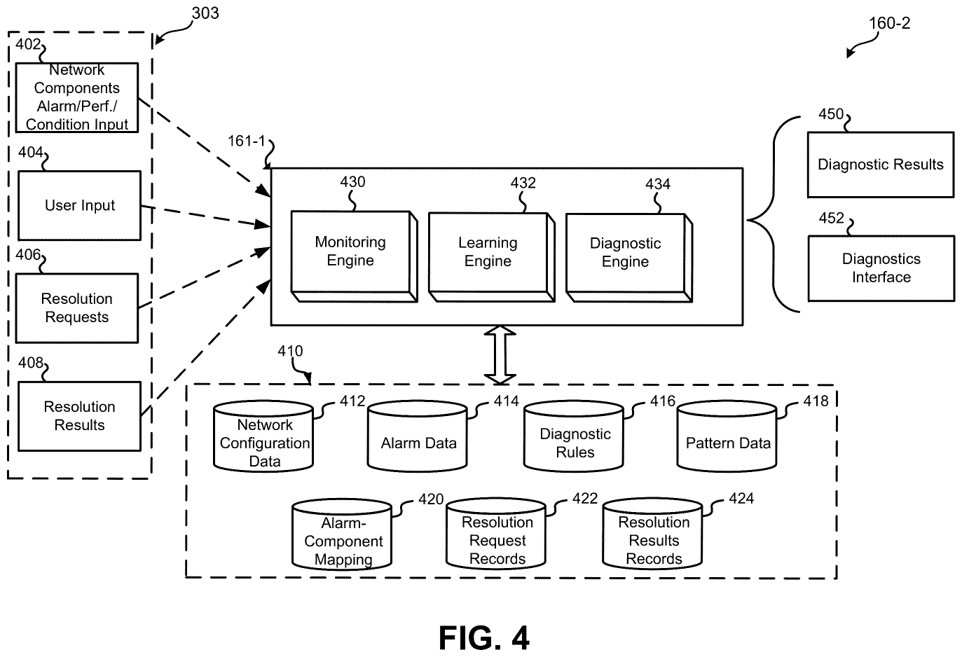

FIG. 4 illustrates a cellular network diagnostics subsystem 160-2 to facilitate cellular network monitoring and diagnostics using the deployed models 311, in accordance with embodiments according to the present disclosure. The subsystem 160-2 may correspond to aspects of the system 100. While the subsystem 160-2 is illustrated as being composed of multiple components, it should be understood that the subsystem 160-2 may be broken into a greater number of components or collapsed into fewer components. Each component may include any one or combination of computerized hardware, software, and/or firmware.

The subsystem 160-2 may include the network diagnostic tool 161-1 and one or more data storage repositories 410, which may be included in or separately from the network diagnostic tool 161-1 and which may be located on the premises of a datacenter or remotely therefrom such as in the cloud. In various embodiments, the network diagnostic tool 161-1 may be or include an artificial intelligence model. Thus, in various embodiments, the network diagnostic tool 161-1 may correspond to or may include one or more deployed models 311. In various embodiments, the one or more deployed models 311 may correspond to one or both of the network diagnostic tool 161-1 and the data repositories 410 and/or data stored therein. In various embodiments, the one or more deployed models 311 may correspond to only part of one or both of the network diagnostic tool 161-1 and the data repositories 410 and/or data stored therein.

The subsystem 400 and the network diagnostic tool 161-1 may be communicatively coupled to the architecture of the system 100. In various embodiments, the network diagnostic tool 161-1 may be deployed in whole or in part at one or more edges of the cellular network system 100. For example, instances of the network diagnostic tool 161-1 may be deployed in whole or in part to one or more UEs 110, base stations 115, RUs 125, cell sites 105, LDCs 117, etc. for use in conjunction with one or more computer systems at those components. In addition or alternative, the network diagnostic tool 161-1 may be deployed in whole or in part with the cloud-based cellular system components. The network diagnostic tool 161-1 may perform operations for cellular network monitoring and diagnostics using the deployed models 311 and/or associated inferences, according to various embodiments.

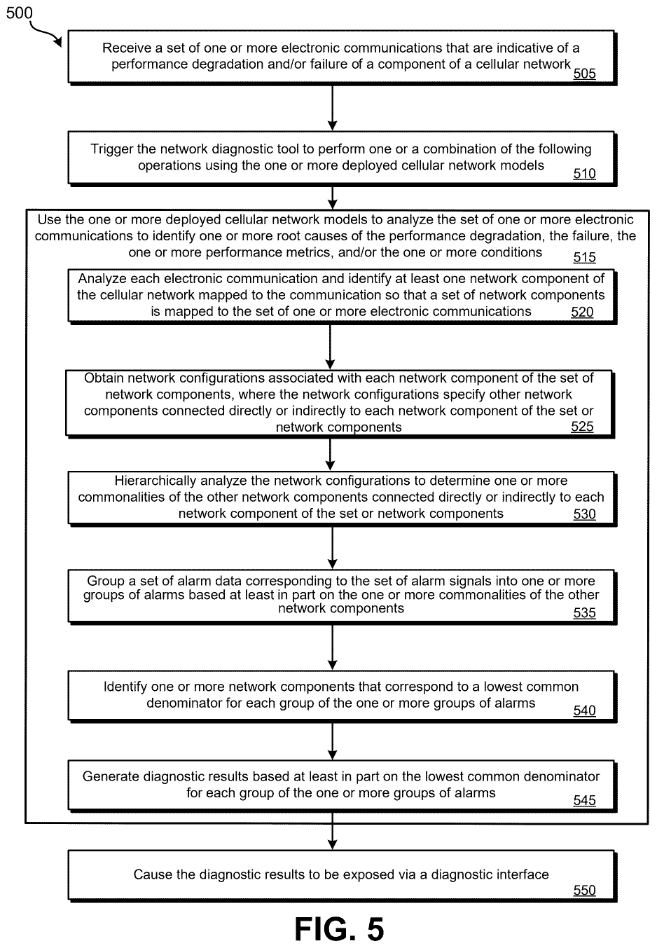

For example, FIG. 5 illustrates one example method 500 for cellular network degradation mitigation using cellular network diagnostics and deployed cellular network models 311 and/or associated sets of inferences, in accordance with embodiments of the present disclosure. One or a combination of the aspects of the method 500 may be performed in conjunction with one or more other aspects disclosed herein, and the method 500 is to be interpreted in view of other features disclosed herein and may be combined with one or more of such features in various embodiments. Teachings of the present disclosure may be implemented in a variety of configurations that may correspond to the configurations disclosed herein. As such, certain aspects of the methods disclosed herein may be omitted, and the order of the steps may be shuffled in any suitable manner and may depend on the implementation chosen. Moreover, while the aspects of the methods disclosed herein, may be separated for the sake of description, it should be understood that certain steps may be performed simultaneously or substantially simultaneously.

As indicated by block 505, a set of one or more electronic communications may be received, where the set of one or more electronic communications is indicative of a performance degradation and/or failure of one or more cellular network components of the cellular network system 100. The set of one or more electronic communications may include one or more alarm signals that are each responsive to a performance degradation and/or failure of one or more cellular network components of the cellular network system 100. Additionally or alternatively, the of one or more electronic communications may include performance data indicative of one or more performance metrics of one or more cellular network components of the cellular network system 100. Additionally or alternatively, the of one or more electronic communications may include condition data indicative of one or more conditions of one or more cellular network components of the cellular network system 100. As indicated by block 510, responsive to the set of one or more electronic communications, the network diagnostic tool 161-1 may be triggered to perform one or a combination of the following operations using the deployed cellular network models 311, trained and adapted as disclosed herein, and/or associated sets of inferences. As indicated by block 515, the deployed cellular network models 311 and/or associated inferences may be used to analyze the set of one or more electronic communications to identify one or more root causes of the performance degradation, the failure, the one or more performance metrics, and/or the one or more conditions. This may, for example, involve one or a combination of the following.

As indicated by block 520, each electronic communication of the set of one or more electronic communications may be analyzed (e.g., using one or more of the deployed cellular network models 311), and at least one network component of the cellular network system 100 mapped to the electronic communication may be identified so that a set of cellular network components is mapped to the set of one or more electronic communications.

As indicated by block 525, network configurations associated with each cellular network component of the set of cellular network components may be obtained, for example, from one or more of the deployed cellular network models 311 and/or from the one or more data storage repositories 410. The network configurations may specify other cellular network components connected directly or indirectly to each cellular network component of the set of cellular network components. As indicated by block 530, the network configurations may be hierarchically analyzed (e.g., using one or more of the deployed cellular network models 311) to determine one or more commonalities of the other network components connected directly or indirectly to each network component of the set of network components.

As indicated by block 535, a set of alarm data, performance data, and/or condition data corresponding to the set of one or more electronic communications may be grouped (e.g., using one or more of the deployed cellular network models 311) into one or more groups of alarm data, performance data, and/or condition data based at least in part on the one or more commonalities of the other cellular network components. As indicated by block 540, one or more network components that correspond to a lowest common denominator for each group of the one or more groups of alarms may be identified (e.g., using one or more of the deployed cellular network models 311). As indicated by block 545, diagnostic results may be generated (e.g., using one or more of the deployed cellular network models 311) based at least in part on the lowest common denominator for each group of the one or more groups of alarms.

As indicated by block 550, the diagnostic results may be caused to be exposed via a diagnostic interface. The diagnostics results may include the one or more groups of alarms grouped based at least in part on the one or more commonalities. Additionally or alternatively, the diagnostics results may include a set of one or more most likely issues causing each group of the one or more groups of alarms based at least in part on the one or more network components that correspond to the lowest common denominator for each group of the one or more groups of alarms and/or one or more tracked resolution requests corresponding to one or more previous alarms and recency of the one or more previous alarms. Additionally or alternatively, the diagnostics results may include a set of one or more most likely issues causing each group of the one or more groups of alarms ranked based at least in part on remedial actions. One or more graphical representations of the one or more groups of alarms, the set of one or more most likely issues may be exposed via the diagnostic interface. Further details regarding the method 500 are disclosed in the following descriptions.

Referring again to FIG. 4, the network diagnostic tool 161-1 may be executed by one or more processors and may be communicatively coupled with interface components and communication channels (which may take various forms in various embodiments as disclosed herein) configured to receive electronic communications 303. The electronic communications 303 may include network components alarm, performance, and/or condition input 402 and user input 404. The subsystem 400 may maintain an inventory of network configuration data 412 (in some embodiments, in the one or more deployed models 311) that shows how the system 100 is put together from a physical perspective and a logical perspective. The network configuration data 412 may include mappings of everything in the system 100—e.g., a mapping of the cell site 105-1 and its connection to the CSR 110-1, which may be connected via a single mode fiber jumper to the NID 115-1, and so on for the entire system 100. Every single link of the system 400 may be mapped out and modeled by the subsystem 400 with specifications for links and terminations (e.g., a particular port is connected to a particular NID 115, etc.). In various embodiments, the repositories 410 may include one or a combination of one or more databases, one or more data systems, one or more inventory systems, and/or the like needed to facilitate the mappings and the one or more deployed models 311.

The subsystem 400 may use the one or more deployed models 311 to process the input 402 and analyze the input 402 to provide for cellular network monitoring and diagnostics features, including generating diagnostic results 450 and generating a diagnostics interface 452 to facilitate presentation of the diagnostic results 452. The network diagnostic tool 161-1 may include a monitoring engine 430 configured to monitor the input 402 and the user input 404. The monitoring engine 430 may also be configured to monitor for resolution requests 406 and resolution results 408. A resolution request 406 may, for example, be generated after the network diagnostic tool 161-1 generates a set of one or more diagnostic results 450 and causes presentation thereof with the diagnostics interface 452.

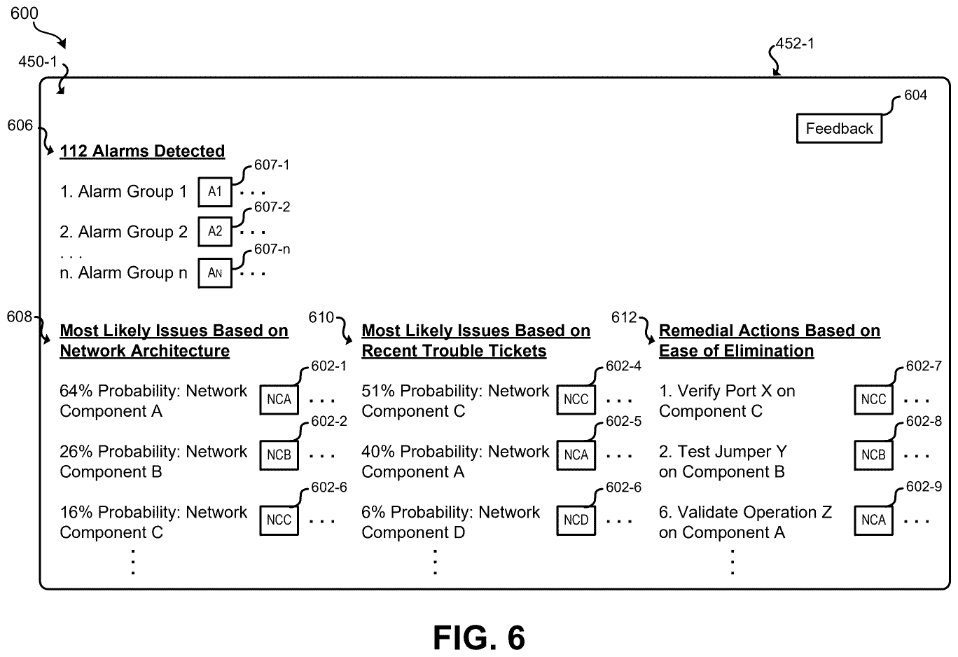

FIG. 6 is an illustration 600 of some aspects of a diagnostics interface 452-1 presenting some aspects of diagnostic results 450-1, in accordance with embodiments according to the present disclosure. In various embodiments, the diagnostics interface 452-1 may be provided via any suitable computing device, such as a desktop workstation, a laptop, a tablet, a smartphone, another mobile device, and/or the like, which may be configured with the network diagnostic tool 161 or may be configured to operate a virtual instance of the network diagnostic tool 161 and/or may be communicatively coupled to other components of the system 100 that include and operate the network diagnostic 161. Selected portions of the diagnostic results 450-1 may be presented with a display. While some examples are presented for illustration purposes, other embodiments are possible.

The diagnostics interface 452-1 may include a set of one or more interface elements corresponding to the one or more diagnostic results 450-1 presented. Some of such interface elements (e.g., elements 602 (602-1, 602-2, . . . 602-9)) may be user-selectable and may be configured to allow for a generation of one or more resolution requests 406 (shown in FIG. 4) corresponding to the issues identified by the diagnostic results 450-1. Thus, for example, with the user-selectable interface elements 602 being presented with the diagnostics interface 452, a user may provide user input 404 (indicated in FIG. 5) to select one or more options to generate a resolution request 406 (e.g., to run a self-test on a particular port, send a field crew to replace an antenna, repair a portion of the fiber network, etc.).

Referring again to FIG. 4, in some embodiments, for example, a resolution request 406 may correspond to a trouble ticket generated based at least in part on the diagnostic results 450. As resolution requests 406 are generated, the network diagnostic tool 161-1, using the one or more deployed models 311, may process the resolution requests 406 and store data corresponding to the resolution requests 406 in a resolution request records data storage 422. Thus, the one or more deployed models 311 may ingest the resolution requests 406 and learn from the resolution requests 406 to further adapt the one or more deployed models 311. The resolution requests records 422 may, for example, correspond to past trouble tickets generated based at least in part on the user input 404 and/or the network diagnostic tool 161-1 and associated with the particular items of alarm data 418 and corresponding network alarm-component mapping data 420. The network alarm-component mapping data 420 may, for example, correspond to data regarding past correlations of particular sets of one or more alarms to corresponding sets of one or more network components that the network diagnostic tool 161-1 performed. Thus, as the network diagnostic tool 161-1 (in some embodiments, the one or more deployed models 311) correlates one or more alarms to one or more network components, the network diagnostic tool 161-1 may store the corresponding mapping data in the alarm component mapping data store 422. For the sake of simplicity and clarity of description, only the examples of alarm data and alarm-component mapping are used and illustrated, even though the features of performance data, performance-component mapping, condition data, and condition-component mapping may be used in like manner in accordance with various embodiments.

The resolution results 408 may correspond to indicia of the results of the actions taken pursuant to the resolution request 406 and may be used in one or more ongoing learning/training modes of the network diagnostic tool 161-1 (e.g., to refine diagnostic rules 416 and pattern data 418 of the one or more deployed models 311 over time). The network diagnostic tool 161-1 may track each resolution request 406 made pursuant to the diagnostic results 450 to determine a corresponding resolution result 408. The resolution result 408 may indicate whether or not one or more remedial actions pursuant to the resolution request 406 were completed, a time of completion, and whether or not the one or more remedial actions were successful in providing a solution to the problem identified by the one or more diagnostic results 450.

The resolution results 408 may be based at least in part on user input 404 that may correspond to, for example, closing a trouble ticket and selecting or otherwise indicating remedial actions and their results. In some embodiments, the network diagnostic tool 161-1 may trace the resolution requests 406 to one or more network components specified by the resolution request 406 and monitor the one or more network components to determine if the one or more components become operational at a time corresponding to completion of the resolution requests 406 (e.g., a time window encompassing the time of completion, with a certain period of time before the detected time of completion and a certain period of time after the detected time of completion). The network diagnostic tool 161-1 may infer that a detection of the one or more components becoming operational contemporaneously with the detected time of completion indicates that the remedial action specified by the resolution request 406 was successful. The network diagnostic tool 161-1 may process the resolution results 408 and store corresponding resolution results data in a resolution results records data store 424.

The network diagnostic tool 161-1 may include a learning engine 432 that may be an analysis engine configured to determine any suitable aspects pertaining to aspects of detection, evaluation, and diagnostics of problems that arise during operation of the system 100 based at least in part on the alarm input 402 received and processed by the monitoring engine 430. The learning engine 432 may include logic to implement and/or otherwise facilitate any taxonomy, classification, categorization, correlation, mapping, qualification, scoring, organization, and/or the like features disclosed herein. In various embodiments, the learning engine 432 may be configured to analyze, classify, categorize, characterize, tag, and/or annotate the alarm data 414, the network configuration data 412, the diagnostic rules 416, the alarm-component mapping 420, the resolution requests 422, the resolution records 424, and the pattern data 418 for the system 100.

In some embodiments, the learning engine 432 may employ one or more artificial intelligence (machine learning or, more specifically, deep learning) algorithms to perform pattern matching to detect patterns 418 of the alarm data 414, the network configuration data 412, the diagnostic rules 416, the alarm-component mapping 420, the resolution requests 422, and/or the resolution records 424 for the system 100. The learning engine 432 may generate, develop, and/or otherwise use the network configuration data 412, the alarm data 414, the alarm-component mapping 420, the diagnostic rules 416, and/or the pattern data 418 based at least in part on the network components alarm input 402 and/or the user input 404. The learning engine 432 may, for example, correlate one or more alarm signals, one or more items of network configuration data 412, one or more diagnostic rules 416, and one or more patterns of the pattern data 418. The learning engine 432 may compile any one or combination of the network configuration data 412, the alarm data 414, the diagnostic rules 416, the alarm-component mapping 420, the resolution requests 422, and/or the resolution results 424 to create, for example, based at least in part on machine-learning, pattern data 418 that may include pattern particulars to facilitate detection, recognition, and differentiation of patterns for alarms, corresponding network components, corresponding diagnostic rules 416, corresponding diagnostic results 450, and/or the like.

The learning engine 432 may include a reasoning module to make logical inferences from a set of the detected and differentiated data to infer one or more patterns 418 of alarm data 418, corresponding network alarm-component mapping data 420, corresponding resolution requests 422, corresponding records of resolution 424 (e.g., past records of attempted resolutions, failed resolutions, and successful resolutions that resulted from the past trouble tickets), and/or the like for past instances of detected alarms, stored resolution requests, and stored resolutions. For instance, the pattern data may include information about any one or combination of alarm histories, corresponding network component histories, corresponding resolution request histories, corresponding resolution histories, and/or the like, any set of which may be used to derive one or more of such patterns. A pattern-based reasoner could be employed to use various statistical techniques in analyzing the data in order to make inferences based on the analysis of the different types of alarm identification data, network component identification data, corresponding resolution request data, and corresponding resolution data, both current and historical. A transitive reasoner may be employed to infer relationships from a set of relationships related to different types of alarm identification data, network component identification data, corresponding resolution request data, and corresponding resolution data.

The monitoring engine 430 and/or the learning engine 432 may facilitate one or more ongoing learning/training modes. The monitoring engine 430 and/or the learning engine 432 may employ an ongoing learning mode to confirm, correct, and/or refine determinations made for diagnostic rules 416, pattern data 418, and diagnostic results 450. For example, having come to one or more conclusions about, and generated, diagnostic rules 416, pattern data 418, and diagnostic results 450, the network diagnostic tool 161-1 may confirm and/or correct the determinations with feedback loop features that may be based at least in part on the user input 404 and/or the resolution results 408. In some embodiments, the diagnostics interface 452 may provide user-selectable feedback options to facilitate the ongoing learning mode. User-selectable via the diagnostics interface 452 provided with notifications (e.g., push notifications, overlays, windows, frames, etc.) could be provided to allow administrative confirmation or correction of conditions detected. The feedback could be used for training the network diagnostic tool 161-1 to heuristically adapt conclusions, specifications, correlations, attributes, triggers, patterns, and/or the like for diagnostic rules 416, pattern data 418, and diagnostic results 450.

The network diagnostic tool 161-1, using the learning engine 432 and/or a diagnostic engine 434, may correlate alarm input 402 to the network configuration data 412, the alarm-component mapping 420, the diagnostic rules 416, and/or the pattern data 418 to determine and generate diagnostic results 450. By way of example, it may be possible for a network operations center to receive a hundred or more alarms at once. When errors and alarms come in from various components of the system 100, the subsystem 400 may utilize the network diagnostic tool 161-1. Thus, for example, the network diagnostic tool 161-1 may receive a large number of alarms with the alarm input 402 within a short time window. The network diagnostic tool 161-1 may store the alarm data corresponding to the alarm signals in an alarm data repository 414. The network diagnostic tool 161-1, configured with diagnostic rules 416, may use the diagnostic rules 416 to determine if all alarms or which alarms are related and determine if and which alarms are related to different events (e.g., a set of alarms could be related to three different events that occurred approximately at the same time). The network diagnostic tool 161-1, for example, using the learning engine 432 and/or the diagnostic engine 434, may analyze the alarm signals to determine what attributes the alarms may have in common and what devices throughout the system 100 the alarms may have in common. The analyses of the network diagnostic tool 161-1 may include differentiating, correlating, and grouping different alarms to determine if and where one or more commonalities exist as shared between one or more of the alarms. Again, such examples with respect to alarms may likewise apply to the features of performance data, performance-component mapping, condition data, and condition-component mapping in accordance with various embodiments.

The correlation results of the grouping of the alarms according to commonalities may be indicated in the network diagnostic interface 452-1, as illustrated in FIG. 6, which indicates a number of alarms 406 detected simultaneously or otherwise contemporaneously within a short time window. The alarm indication 606 may present the alarm groupings. Each alarm group may be presented with one or more user-selectable options 607 (607-1, 607-2, . . . , 607-n) configured to allow for selection to reveal further details (e.g., a corresponding site identifier, a device identifier, a network identifier, a port identifier, a type of alarm, a condition, the one or more commonalities of each group, the lowest common denominator network component for each group, and/or the like) regarding each alarm group and the alarms included therein and to allow for generation of one or more resolution requests by the network diagnostic tool 161-1 or communicatively coupled issue tracking system of the system 100.

Referring again to FIG. 4, the network diagnostic tool 161-1 may include the diagnostic engine 434, which may be configured to determine and generate the diagnostic results 450, as well as generate the diagnostics interface 452. The network diagnostic tool 161-1, using the learning engine 432 and/or the diagnostic engine 434, may identify one or more commonalities shared by one or more alarms. Likewise, the network diagnostic tool 161-1, using the learning engine 432 and/or the diagnostic engine 434, may identify one or more commonalities that do not exist among the alarms. For example, if, say, 590 sites are up and 10 are down, the network diagnostic tool 161-1 may recognize that the issue is not due to an aggregation point for all 600 sites, such as a router connecting all of them because the router is either operational or not. However, the network diagnostic tool 161-1 may recognize that the issue could be due to a set of one or more ports on the routers, as opposed to the entire router.

The analyses may involve the network diagnostic tool 161-1 examining network configuration data 412 for mappings and specifications of the components of the architecture of this system 100 indicated by the alarms and related to such components to identify any commonalities of links, of devices, of circuits, etc. Having identified one or more commonalities, the network diagnostic tool 161-1, using the learning engine 432 and/or the diagnostic engine 434, may determine the lowest point of commonality for each set of alarms using the diagnostic rules 416. According to the diagnostic rules 416, this may involve identifying immediate sources of alarms, such as those indicated in each alarm signal, then analyzing the network components that are hierarchically related to the sources in the architecture of the system 100. The hierarchical examination specified by the diagnostic rules 416 may include examining similar sites at a particular level in the hierarchy to determine whether or not all components at that level are experiencing problems indicated by the alarms or other corresponding problems. The hierarchical examination may then include examining one or more lower levels within the hierarchy for components that may also be experiencing problems indicated by, or otherwise corresponding to, the alarms.

The diagnostic rules 416 may specify checking various components of the system 100 that are similar to the alarm-triggering components (e.g., connected to the alarm-triggering components, at the same level in the hierarchy as the alarm-triggering components, hierarchically related to the alarm-triggering components, or otherwise related to the alarm-triggering components) that may be up and running. For example, the network diagnostic tool 161-1 may check the similar components to determine whether they are up and running just because they had a failover due to redundancy measures. This may involve analyzing the alarm input 402 to determine whether alarms were triggered for the similar components and, in some embodiments, polling the components for data or other indicia of a failover. Accordingly, the network diagnostic tool 161-1 may also include detection of failover instances in its analyses.

Thus, based at least in part on the lowest point of commonality for a group of alarms, the network diagnostic tool 161-1, using the learning engine 432 and/or the diagnostic engine 434, may identify the lowest common denominator likely causing a problem that triggers the group of alarms. For example, according to the diagnostic rules 416, if, say, 600 sites go down, then the network diagnostic tool 161-1 may recognize that the problem may be due to an NNI with a carrier A, B, or C. If only one NNI is lost, then the diagnostic rules 416 may point to a port of the NNI that may not be operational. However, if, say, 1500 sites go down, then the network diagnostic tool 161-1 may recognize it is not just due to an NNI, as there may be three NNIs down across three different carriers, and the network diagnostic tool 161-1 may flag the edge router in the EDC as potentially being the problem because it is the lowest common denominator that would cause that level of impact. As another example, the diagnostic rules 416 may factor in that there can be one to ten or more fiber providers and networks in a given market, where each carrier may provide a particular fiber network. If ten sites are down out in field, then the lowest common denominator may correspond to all the sites being linked to a particular fiber network and all on one NNI in the same geographical area.

The network diagnostic tool 161-1 may not only perform diagnostics with respect to transport components (e.g., fiberoptics, transports, data centers, etc.), but also may perform diagnostics with respect to radio network components. The network diagnostic tool 161-1 may be configured to examine the architecture of the cell site, examine LDCs, among other components, and determine most likely set of one or more causes of the one or more issues. For example, the network diagnostic tool 161-1 may analyze signals indicating a radio being down on a tower and determine whether there is a high probability of water in a line preventing proper reflection/propagation of RF signals or of different equipment failures whether it be a distributed unit (DU) or a centralized unit (CU). If there is one antenna with six ports connected to six ports on an RF transmitting radio and one or more alarms are correlated to one line, then the network diagnostic tool 161-1 may determine that there is a high probability that the jumper between the radio and the antenna is the problem. However, if one or more alarms are correlated to all six ports, then the network diagnostic tool 161-1 may determine that there is a high probability that the whole antenna is the problem.

Accordingly, the diagnostic rules 416 may include criteria for identifying issues corresponding to the alarm input 402. The learning engine 432 and/or the diagnostic engine 434 may also use the diagnostic rules 416 to qualify the identified potential issues according to a graduated diagnostic scale. Any suitable diagnostic scale may be used in various embodiments. In some embodiments, a diagnostic scale could entail a categorization scheme, with categories such as strong identification, possible identification, and weak identification as the potential cause of a set of one or more alarms.

In some embodiments, a diagnostic scale may entail a diagnostic scoring system. The diagnostic scoring system may score an identified potential issue with a numerical expression, for example, an identification score. For example, in some embodiments, an identification score may be an assessment of a probably that the identified potential issue is the actual cause of a set of one or more alarms, taking into account a number of factors, each of which may be weighted differently. By way of example, a diagnostic scale may include a range of identification scores from 0 to 100, or from 0 to 1,000, with the high end of the scale indicating greater probability. Some embodiments may use methods of statistical analysis to derive an identification score. Various embodiments may determine an identification score based on any one or more suitable quantifiers. An identification score may be based at least in part on the extent to which detected characteristics of the captured data match previously determined characteristics stored in the specifications. In some embodiments, an identification score may be cumulative of scores based on matching each type of the characteristics. With an identification score determined, categorizations may be made based on the score. By way of example without limitation, a score correlated to a 75-100% band may be deemed a positive identification of a cause; a score correlated to a 70-75% band may be deemed a possible identification; a score correlated to a 45-50% band may be deemed a weak identification; and a score below a 45% minimum threshold may be deemed a weak/insufficient identification.

The network diagnostic tool 161-1 (e.g., using the diagnostic engine 434) may rank identified potential causes according to the scoring of each. Referring to FIG. 6, based in part on such analyses and scoring, the network diagnostic tool 161-1 may cause presentation of the most likely issues based on the network architecture 608 via the network diagnostic interface 452-1. The potential causes may be presented in a ranked order according to the probability that the network diagnostic tool 161-1 determined for each potential cause.

In some embodiments, the network diagnostic tool 161-1 may correlate the identified potential causes to previous resolution requests 422 and corresponding resolution results 424 collected over time. The network diagnostic tool 161-1 may, for example, identify the three most likely issues from a network architecture perspective (e.g., 608 in FIG. 6) but may be able to identify the most common fault based at least in part on the resolution requests 422 and resolution results 424 in the last six months. Thus, the ranked potential causes may be filtered according to observed resolution requests 422 and corresponding resolution results 424. The most likely issues based on recent resolution requests/results may be indicated via the diagnostic interface 452 (e.g., 610 in FIG. 6). In some embodiments, relationships of potential causes to observed resolution requests 422 and corresponding resolution results 424 may be a factor in the scoring of the potential causes.

In some embodiments, the observed resolution requests 422 and corresponding resolution results 424 may be tagged with recency attributes that correspond to time parameters respectively indicating when the requests 422 were instantiated and when the resolution results 424 were finalized. The recency attributes may be used in selecting resolution requests 422 and resolution results 424 according to a rolling time window. Accordingly, identification of potential causes may be a function of recency of observed resolution requests 422 and resolution results 424.

Additionally, the network diagnostic tool 161-1 may correlate the identified potential causes to remedial actions based on ease of elimination, that is, based on one or a combination of speed, simplicity, and/or effort necessary to perform a test, validation, or another remedial action in order to verify or eliminate a potential cause from consideration. Specifications of remedial actions may, for example, be stored in the diagnostic rules repository 416. The specifications of remedial actions may be tagged with ease of elimination attributes that correspond to a score of each remedial action based on ease of elimination.

In some embodiments, the scoring of remedial actions may be a function of one or a combination of user input 404 indicating ease of elimination, feedback (e.g., user-supplied feedback consequent to selection of one or more feedback options 604) indicating ease of elimination comma, and/or analyses of resolution requests 422 and corresponding resolution results 424 by the network diagnostic tool 161-1. For example, the learning engine 432 examine resolution request 422 and corresponding resolution results 424 to determine differences of time between initiation of the resolution requests 422 and completion of the corresponding resolution results 424. Based at least in part on the temporal differences, the learning engine 432 may identify which types of past remedial actions took less time to perform (e.g., had relatively short time spans between request initiation and resolution completion) relative to other remedial actions. The learning engine 432 may rank the remedial actions accordingly. In some embodiments, the rankings may be indicated in the ease of elimination attributes. The diagnostic engine 432 may use the ease of elimination attributes of remedial actions mapped to the identified potential causes (e.g., 608 and/or 610 in FIG. 6) to rank the potential causes according to ease of elimination. The remedial actions based on ease of elimination 612 may be presented via the diagnostic interface 452-1, as indicated, for example, in FIG. 6.

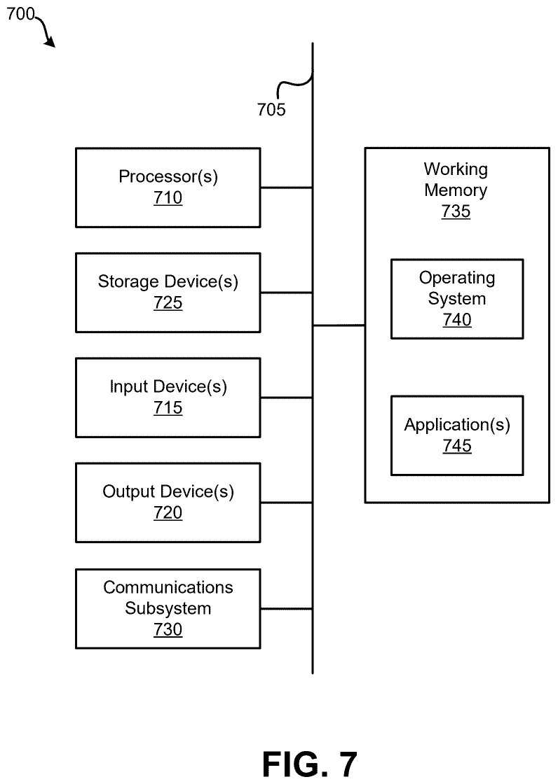

A computer system as illustrated in FIG. 7 may be incorporated as part of the computerized devices that may be used for the network diagnostic tool 161 and other computer components disclosed above. FIG. 7 provides a schematic illustration of one embodiment of a computer system 700 that can perform various steps of the methods provided by various embodiments. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements may include one or more processors 710, including without limitation one or more general-purpose processors and/or one or more special-purpose processors (such as digital signal processing chips, graphics acceleration processors, video decoders, and/or the like); one or more input devices 715, which can include without limitation a mouse, a keyboard, remote control, and/or the like; and one or more output devices 720, which can include without limitation a display device, a printer, and/or the like.

The computer system 700 may further include (and/or be in communication with) one or more non-transitory storage devices 725, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data storages, including without limitation, various file systems, database structures, and/or the like.

The computer system 700 might also include a communications subsystem 730, which can include without limitation a modem, a network card (wireless or wired), an infrared communication device, a wireless communication device, and/or a chipset (such as a Bluetooth™ device, an 802.11 device, a Wi-Fi device, a WiMAX device, cellular communication device, etc.), and/or the like. The communications subsystem 730 may permit data to be exchanged with a network (such as the network described below, to name one example), other computer systems, and/or any other devices described herein. In many embodiments, the computer system 700 will further comprise a working memory 735, which can include a RAM or ROM device, as described above.

The computer system 700 also can comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 725 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure, and/or adapt a general-purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.), then takes the form of executable code.

As mentioned above, in one aspect, some embodiments may employ a computer system (such as the computer system 700) to perform methods in accordance with various embodiments of the invention. According to a set of embodiments, some or all of the procedures of such methods are performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the non-transitory storage device(s) 725. Merely by way of example, execution of the sequences of instructions contained in the working memory 735 might cause the processor(s) 710 to perform one or more procedures of the methods described herein.

The terms “machine-readable medium,” “machine-readable media,” “computer-readable storage medium,” “computer-readable storage media,” “computer-readable medium,” “computer-readable media,” “processor-readable medium,” “processor-readable media,” and/or like terms as used herein, refer to any medium that participates in providing data that causes a machine to operate in a specific fashion. These mediums may be non-transitory. In an embodiment implemented using the computer system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 725. Volatile media include, without limitation, dynamic memory, such as the working memory 735.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 730 (and/or components thereof) generally will receive signals, and the bus 705 then might carry the signals (and/or the data, instructions, etc. carried by the signals) to the working memory 735, from which the processor(s) 710 retrieves and executes the instructions. The instructions received by the working memory 735 may optionally be stored on a non-transitory storage device 725 either before or after execution by the processor(s) 710.

It should further be understood that the components of computer system 700 can be distributed across a network. For example, some processing may be performed in one location using a first processor while other processing may be performed by another processor remote from the first processor. Other components of computer system 700 may be similarly distributed. As such, computer system 700 may be interpreted as a distributed computing system that performs processing in multiple locations. In some instances, computer system 700 may be interpreted as a single computing device, such as a distinct laptop, desktop computer, or the like, depending on the context.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations may be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

Furthermore, the example embodiments described herein may be implemented as logical operations in a computing device in a networked computing system environment. The logical operations may be implemented as: (i) a sequence of computer implemented instructions, steps, or program modules running on a computing device; and (ii) interconnected logic or hardware modules running within a computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, the terms in the claims have their plain, ordinary meaning unless otherwise explicitly and clearly defined by the patentee. The indefinite articles “a” or “an,” as used in the claims, are defined herein to mean one or more than one of the element that the particular article introduces; and subsequent use of the definite article “the” is not intended to negate that meaning. Furthermore, the use of ordinal number terms, such as “first,” “second,” etc., to clarify different elements in the claims is not intended to impart a particular position in a series, or any other sequential character or order, to the elements to which the ordinal number terms have been applied.

What is claimed:

1. A method for cellular network degradation mitigation, the method comprising:
processing a first plurality of electronic communications received via a network from a plurality of electronic devices of a cellular network system, the first plurality of electronic communications comprising one or more of:
alarm signals that are each responsive to a performance degradation and/or a failure of one or more cellular network components of the cellular network system;
first performance data indicative of performance metrics of cellular network components of the cellular network system; and/or
first condition data indicative of conditions of cellular network components of the cellular network system;
forming a plurality of data composites from the first plurality of electronic communications at least in part by, for each electronic communication of the electronic communications:
processing the electronic communication to identify one or more digital identifiers mapped to one or more of the components of the cellular network system;
extracting and caching a data portion from the electronic communication; and
appending one or more tags to the data portion that indicate: the one or more digital identifiers; a temporal specification corresponding to origination of the data portion; and/or a recognition specification indicative of a recognized type of alarm signal, performance data, and/or condition data corresponding to the data portion;
using at least some of the plurality of data composites to automatically train one or more cellular network models to create one or more adapted cellular network models; and
generating diagnostic results mapped to particular portions of the cellular network system based at least in part on the one or more adapted cellular network models.

2. The method for cellular network degradation mitigation as recited in claim 1, further comprising causing the diagnostic results to be exposed via a diagnostic interface.

3. The method for cellular network degradation mitigation as recited in claim 1, further comprising:
processing a set of one or more electronic communications received via the network from one or more electronic devices of the cellular network system, the set of one or more electronic communications comprising one or more of:
one or more alarm signals that are each responsive to a performance degradation and/or failure of one or more cellular network components of the cellular network system;
second performance data indicative of one or more performance metrics of one or more cellular network components of the cellular network system; and/or
second condition data indicative of one or more conditions of one or more cellular network components of the cellular network system; and
using the one or more adapted cellular network models to analyze the set of one or more electronic communications to identify one or more root causes of the performance degradation, the failure, the one or more performance metrics, and/or the one or more conditions.

4. The method for cellular network degradation mitigation as recited in claim 1, wherein the generating the diagnostic results is based at least in part on the identified one or more root causes.

5. The method for cellular network degradation mitigation as recited in claim 2, further comprising:
pushing the one or more adapted cellular network models to one or more edges of the cellular network system, wherein the one or more adapted cellular network models are used to analyze the set of one or more electronic communications at the one or more edges of the cellular network system.

6. The method for cellular network degradation mitigation as recited in claim 5, wherein the generating the diagnostic results is performed at the one or more edges of the cellular network system, and the diagnostic results to be exposed via the diagnostic interface at a computing device at the one or more edges of the cellular network system.

7. The method for cellular network degradation mitigation as recited in claim 1, wherein the training the one or more cellular network models corresponds to using the at least some of the plurality of data composites to automatically train a plurality of cellular network models to create a plurality of adapted cellular network models.

8. The method for cellular network degradation mitigation as recited in claim 7, wherein each cellular network model of the plurality of adapted cellular network models is particularized to a particular type of cellular network component, and no model of the plurality of adapted cellular network models is particularized to the same type of cellular network component as another model of the plurality of adapted cellular network models.

9. A system to facilitate cellular network degradation mitigation, the method comprising:
one or more processing devices; and
memory readable by the one or more processing devices and having stored therein processor-readable instructions which, when executed by the one or more processing devices, cause the system to perform operations comprising:
processing a first plurality of electronic communications received via a network from a plurality of electronic devices of a cellular network system, the first plurality of electronic communications comprising one or more of:
alarm signals that are each responsive to a performance degradation and/or a failure of one or more cellular network components of the cellular network system;
first performance data indicative of performance metrics of cellular network components of the cellular network system; and/or
first condition data indicative of conditions of cellular network components of the cellular network system;
forming a plurality of data composites from the first plurality of electronic communications at least in part by, for each electronic communication of the electronic communications:
processing the electronic communication to identify one or more digital identifiers mapped to one or more of the components of the cellular network system;
extracting and caching a data portion from the electronic communication; and
appending one or more tags to the data portion that indicate: the one or more digital identifiers; a temporal specification corresponding to origination of the data portion; and/or a recognition specification indicative of a recognized type of alarm signal, performance data, and/or condition data corresponding to the data portion;
using at least some of the plurality of data composites to automatically train one or more cellular network models to create one or more adapted cellular network models; and
generating diagnostic results mapped to particular portions of the cellular network system based at least in part on the one or more adapted cellular network models.

10. The system to facilitate cellular network degradation mitigation as recited in claim 9, the operations further comprising causing the diagnostic results to be exposed via a diagnostic interface.

11. The system to facilitate cellular network degradation mitigation as recited in claim 9, the operations further comprising:
processing a set of one or more electronic communications received via the network from one or more electronic devices of the cellular network system, the set of one or more electronic communications comprising one or more of:
one or more alarm signals that are each responsive to a performance degradation and/or failure of one or more cellular network components of the cellular network system;
second performance data indicative of one or more performance metrics of one or more cellular network components of the cellular network system; and/or
second condition data indicative of one or more conditions of one or more cellular network components of the cellular network system; and
using the one or more adapted cellular network models to analyze the set of one or more electronic communications to identify one or more root causes of the performance degradation, the failure, the one or more performance metrics, and/or the one or more conditions.

12. The system to facilitate cellular network degradation mitigation as recited in claim 9, wherein the generating the diagnostic results is based at least in part on the identified one or more root causes.

13. The system to facilitate cellular network degradation mitigation as recited in claim 10, the operations further comprising:
pushing the one or more adapted cellular network models to one or more edges of the cellular network system, wherein the one or more adapted cellular network models are used to analyze the set of one or more electronic communications at the one or more edges of the cellular network system.

14. The system to facilitate cellular network degradation mitigation as recited in claim 13, wherein the generating the diagnostic results is performed at the one or more edges of the cellular network, and the diagnostic results to be exposed via the diagnostic interface at a computing device at the one or more edges of the cellular network.

15. The system to facilitate cellular network degradation mitigation as recited in claim 9, wherein the training the one or more cellular network models corresponds to using the at least some of the plurality of data composites to automatically train a plurality of cellular network models to create a plurality of adapted cellular network models.

16. The system to facilitate cellular network degradation mitigation as recited in claim 15, wherein each cellular network model of the plurality of adapted cellular network models is particularized to a particular type of cellular network component, and no model of the plurality of adapted cellular network models is particularized to the same type of cellular network component as another model of the plurality of adapted cellular network models.

17. One or more non-transitory, machine-readable media having machine-readable instructions thereon which, when executed by one or more processing devices, cause a system to perform operations comprising:
processing a first plurality of electronic communications received via a network from a plurality of electronic devices of a cellular network system, the first plurality of electronic communications comprising one or more of:
alarm signals that are each responsive to a performance degradation and/or a failure of one or more cellular network components of the cellular network system;
first performance data indicative of performance metrics of cellular network components of the cellular network system; and/or
first condition data indicative of conditions of cellular network components of the cellular network system;
forming a plurality of data composites from the first plurality of electronic communications at least in part by, for each electronic communication of the electronic communications:
processing the electronic communication to identify one or more digital identifiers mapped to one or more of the components of the cellular network system;
extracting and caching a data portion from the electronic communication; and
appending one or more tags to the data portion that indicate: the one or more digital identifiers; a temporal specification corresponding to origination of the data portion; and/or a recognition specification indicative of a recognized type of alarm signal, performance data, and/or condition data corresponding to the data portion;
using at least some of the plurality of data composites to automatically train one or more cellular network models to create one or more adapted cellular network models; and
generating diagnostic results mapped to particular portions of the cellular network system based at least in part on the one or more adapted cellular network models.

18. The one or more non-transitory, machine-readable media as recited in claim 17, the operations further comprising causing the diagnostic results to be exposed via a diagnostic interface.

19. The one or more non-transitory, machine-readable media as recited in claim 17, the operations further comprising:
processing a set of one or more electronic communications received via the network from one or more electronic devices of the cellular network system, the set of one or more electronic communications comprising one or more of:
one or more alarm signals that are each responsive to a performance degradation and/or failure of one or more cellular network components of the cellular network system;
second performance data indicative of one or more performance metrics of one or more cellular network components of the cellular network system; and/or
second condition data indicative of one or more conditions of one or more cellular network components of the cellular network system; and
using the one or more adapted cellular network models to analyze the set of one or more electronic communications to identify one or more root causes of the performance degradation, the failure, the one or more performance metrics, and/or the one or more conditions.

20. The one or more non-transitory, machine-readable media as recited in claim 17, wherein the generating the diagnostic results is based at least in part on the identified one or more root causes.
